(19) United States
(12) Patent Application Publication
(10) Pub. No.: US 2009/0305645 A1
(43) Pub. Date: Dec. 10, 2009

(54) Radio Communication Device

(75) Inventor: Tadayuki Watanabe, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/162,340

(22) PCT Filed: Jan. 24, 2007
(86) PCT No.: PCT/JP2007/051104

§ 371 Date: Jan. 28, 2009

(30) Foreign Application Priority Data
Jan. 27, 2006 (JP) 2006-019477
Jan. 27, 2006 (JP) 2006-019484
Jan. 27, 2006 (JP) 2006-019485

(51) Int. Cl. H04B 1/38

(52) U.S. Cl. 455/73

(57) ABSTRACT

A radio communication terminal 200A according to the present invention, when an operation requiring transmission of non-delivery information is performed while a BCMCS processor 207 is receiving delivery information via a radio communication unit 201, controls whether or not to transmit the non-delivery information according to the operation on the basis of either a content of the non-delivery information according to the operation or a state of the delivery information being received by the BCMCS processor 207.

### TECHNICAL FIELD

The present invention relates to a radio communication device used in a mobile communication system. Specifically, the present invention relates to a radio communication device in which one radio communication unit is shared by a delivery information processor which receives delivery information such as a video image, and a communication processor which executes processing related to transmission/reception of voice calls, e-mails and the like.

### BACKGROUND ART

In a mobile communication system using code division multiple access (CDMA), various communication services using a high-speed data communication function, e.g., 1x evolution-data only (1xEV-DO), are provided.

In the mobile communication system using 1xEV-DO in recent years, BCMCS (broadcast/multicast services) are provided which simultaneously deliver contents including video images and the like to a large number of radio communication devices (for example, radio communication terminals, radio communication card modules connected to car navigation systems, and the like) by broadcast or multicast (for example, Non-patent document 1).

Non-patent document 1: “CDMA 2000 High Rate Broadcast-Multicast Packet Data Air Interface Specification (C.S0054-0 Version 1.0)-Section 1: Overview,” 3GPP2, February, 2004

### DISCLOSURE OF THE INVENTION

In the conventional radio communication device described above, one radio communication unit is shared by a delivery information processor, which executes processing related to contents delivered by BCMCS (hereinafter appropriately abbreviated as “delivery information”), and a communication processor, which executes processing related to transmission/reception of information other than the delivery information such as voice calls, e-mails and the like (hereinafter appropriately abbreviated as “non-delivery information”).

Therefore, there has been a problem that the conventional radio communication device cannot transmit or receive the non-delivery information while receiving the delivery information.

That is, when the reception of the delivery information and the transmission/reception of the non-delivery information conflict with each other, the user of the radio communication device has to select any one of the reception of the delivery information and the transmission/reception of the non-delivery information every time. Therefore, there has been a problem that operation of the radio communication device performed by the user is complicated or opportunities for the reception of the delivery information are missed.

The present invention has been made in view of such situation, and has an object of providing a radio communication device in which a radio communication unit is shared for receiving delivery information and transmitting or receiving non-delivery information, the radio communication device having operability improved thereof and being capable of reliably receiving necessary delivery information.

In order to solve the problem described above, the present invention has the following aspects. First, a first aspect of the present invention is a radio communication device (for example, radio communication terminal 200A) comprising a delivery information processor (BCMCS processor 207) which receives delivery information on identical contents simultaneously delivered to a plurality of transmission destinations, a communication processor (communication processor 205) which executes a processing relating to transmission or reception of non-delivery information other than the delivery information, a radio communication unit (radio communication unit 201) which is shared by the delivery information processor and the communication processor, and selects and processes any one of the delivery information and the non-delivery information, and a controller which, when an operation requiring the transmission of the non-delivery information (for example, voice calls) is performed while the delivery information is being received by the delivery information processor via the radio communication unit, controls whether or not to transmit transmission non-delivery information on the basis of a content of the transmission non-delivery information (delivery contents C1) according to the operation or a state of reception delivery information (voice call data V1) being received by the delivery information processor.

A second aspect of the present invention is the radio communication device having the first aspect of the present invention, further comprising a selection processor (operation unit 211 and display unit 213) which lets a user of the radio communication device select any one of continuation of reception of the reception delivery information and the transmission of the transmission non-delivery information, when an information amount of an unreceived portion (unreceived portion C1a) not yet received of the reception delivery information is greater than or equal to a predetermined threshold value, wherein the controller controls whether or not to transmit the transmission non-delivery information on the basis of an instruction from the selection processor.

A third aspect of the present invention is the radio communication device having the first aspect of the present invention, wherein the controller transmits the transmission non-delivery information after the reception of the reception delivery information is completed, when the information amount of the unreceived portion not yet received of the reception delivery information is less than the predetermined threshold value.

A fourth aspect of the present invention is the radio communication device having the first aspect of the present invention, wherein the controller controls whether or not to transmit the transmission non-delivery information on the basis of a transmission destination identifier (for example, phone number) indicating a transmission destination of the transmission non-delivery information.

A fifth aspect of the present invention is the radio communication device having the first aspect of the present invention, further comprising a designation processor (operation unit 211 and display unit 213) which lets the user of the radio communication device designate priority delivery information (for example, today's news) to be received in priority over the transmission or reception of the non-delivery information, and stores a priority delivery information identifier indicating the designated priority delivery information in the storage unit, wherein the controller cancels the transmission or reception of the non-delivery information and continues the reception of the reception delivery information, when the reception delivery information matches with the priority delivery information identifier stored in the storage unit.

A sixth aspect of the present invention is a radio communication device (for example, radio communication terminal 200A) comprising a delivery information processor (BCMCS processor 207) which receives delivery information on identical contents simultaneously delivered to a plurality of transmission destinations, a communication processor (communication processor 205) which executes a processing relating to transmission or reception of non-delivery information (voice call data V2) other than the delivery information, a radio communication unit (radio communication unit 201) which is shared by the delivery information processor and the communication processor, and selects and processes any one of the delivery information and the non-delivery information, a storage unit (storage unit 209) which stores at least a delivery timing (timing t13) of the delivery information, and a controller (controller 203) which, when the delivery timing stored in the storage unit comes during the transmission or reception of the non-delivery information by the communication processor via the radio communication unit, controls whether or not to continue the transmission or reception of the non-delivery information on the basis of a content of target delivery information (delivery contents C2) which is an object of the reception.

A seventh aspect of the present invention is the radio communication device having the sixth aspect of the present invention, wherein the controller continues the transmission or reception of the non-delivery information, when the target delivery information is to be redelivered after the delivery timing (at a timing t14).

An eighth aspect of the present invention is the radio communication device having the sixth aspect of the present invention, wherein the controller makes a notification that the target delivery information is not to be redelivered while continuing the transmission or reception of the non-delivery information, when the target delivery information is not to be redelivered after the delivery timing.

A ninth aspect of the present invention is the radio communication device having the sixth aspect of the present intention, further comprising a designation processor (operation unit 211 and display unit 213) which lets the user of the radio communication device designate priority delivery information (for example, today's news) to be received in priority over the transmission or reception of the non-delivery information, and stores the designated priority delivery information in the storage unit, wherein the controller aborts the transmission or reception of the non-delivery information and receives the target delivery information, when the target delivery information matches with the priority delivery information stored in the storage unit.

A tenth aspect of the present invention is the radio communication device having the sixth aspect of the present invention, wherein the controller controls whether or not to continue the transmission or reception of the non-delivery information on the basis of a transmission destination identifier (for example, phone number) indicating a transmission destination or a transmission source of the non-delivery information.

An eleventh aspect of the present invention is a radio communication device (for example, radio communication terminal 200A) comprising a delivery information processor (BCMCS processor 207) which receives delivery information on identical contents simultaneously delivered to a plurality of transmission destinations, a communication processor (communication processor 205) which executes a process relating to transmission or reception of non-delivery information other than the delivery information, a radio communication unit (radio communication unit 201) which is shared by the delivery information processor and the communication processor, and selects and processes any one of the delivery information and the non-delivery information, a storage unit (storage unit 209) which stores at least a delivery timing (timing t22) of the delivery information, and a controller (controller 203) which, when an operation requiring the transmission of the non-delivery information is performed between a determination timing (timing t21) which is a predetermined time before the delivery timing stored in the storage unit and the delivery timing, controls whether or not to transmit the non-delivery information on the basis of a content of transmission non-delivery information (voice call data V3) according to the operation or a content of target delivery information (delivery contents C3) which is an object of the reception by the delivery information processor.

A twelfth aspect of the present invention is the radio communication device having the eleventh aspect of the present invention, wherein the controller transmits the transmission non-delivery information, when the target delivery information is to be redelivered after the delivery timing (at a timing t23).

A thirteenth aspect of the present invention is the radio communication device having the eleventh aspect of the present invention, wherein the controller makes a notification that the target delivery information is not to be redelivered before transmitting the transmission non-delivery information, when the target delivery information is not to be redelivered after the delivery timing.

A fourteenth aspect of the present invention is the radio communication device having the eleventh aspect of the present invention, further comprising a designation processor (operation unit 211 and display unit 213) which lets the user of the radio communication device designate priority delivery information (for example, today's news) to be received in priority over the transmission or reception of the non-delivery information, and stores a priority delivery information identifier indicating the designated priority delivery information in the storage unit, wherein the controller cancels the transmission non-delivery information and receives the target delivery information, when the target delivery information matches with the priority delivery information identifier stored in the storage unit.

A fifteenth aspect of the present invention is the radio communication device having the eleventh aspect of the present invention, wherein the controller controls whether or not to transmit the non-delivery information on the basis of a transmission destination identifier (for example, phone number) indicating a transmission destination of the transmission non-delivery information.

According to the aspects of the present invention, a radio communication device having a radio communication unit shared for reception of delivery information and services other than the reception of the delivery information, in which operability of the radio communication device is improved and in which necessary delivery information can be more reliably received, can be provided.

### BRIEF DESCRIPTION OF THE DRAWINGS

FIG. 1 is an overall schematic configuration diagram of a mobile communication system according to an embodiment of the present invention.

FIG. 2 is a functional block configuration diagram of a radio communication device according to the embodiment of the present invention.

FIG. 3 is an operation flowchart for when the radio communication device according to the embodiment of the present invention starts a voice call during reception of delivery information delivered by BCMCS.

FIG. 4 is an operation flowchart for when the radio communication device according to the embodiment of the present invention transmits e-mail during reception of the delivery information.

FIG. 5 is an operation flowchart for when the radio communication device according to the embodiment of the present invention receives delivery information delivered by the BCMCS during the voice call.

FIG. 6 is an operation flowchart for when a delivery time of the delivery information to be delivered by the BCMCS is approaching at a start of the voice call by the radio communication device according to the embodiment of the present invention.

FIG. 7 is a diagram showing states of the delivery information and non-delivery information transmitted or received by the radio communication device according to the embodiment of the present invention.

FIG. 8 is a diagram showing states of the delivery information and the non-delivery information transmitted or received by the radio communication device according to the embodiment of the present invention.

FIG. 9 is a diagram showing states of the delivery information and the non-delivery information transmitted or received by the radio communication device according to the embodiment of the present invention.

FIG. 10 is an example of a screen displayed by the radio communication device according to the embodiment of the present invention.

FIG. 11 is an example of a screen displayed by the radio communication device according to the embodiment of the present invention.

FIG. 12 is an example of a screen displayed by the radio communication device according to the embodiment of the present invention.

FIG. 13 is an example of a screen displayed by the radio communication device according to the embodiment of the present invention.

FIG. 14 is an example of a screen displayed by the radio communication device according to the embodiment of the present invention.

FIG. 15 is an example of a screen displayed by the radio communication device according to a modified example of the present invention.

### BEST MODE FOR CARRYING OUT THE INVENTION

Next, an embodiment of the present invention will be described. Note that the same or similar portions are denoted by the same or similar reference numerals in the descriptions in the drawings below. It should be noted that the drawings are schematic, and that ratios of respective dimensions and the like differ from those in reality.

Thus, specific dimensions and the like should be determined in consideration of the descriptions below. It is needless to say that some of the dimensional relations and ratios differ amongst the drawings as well.

### (Overall Schematic Configuration of Mobile Communication System)

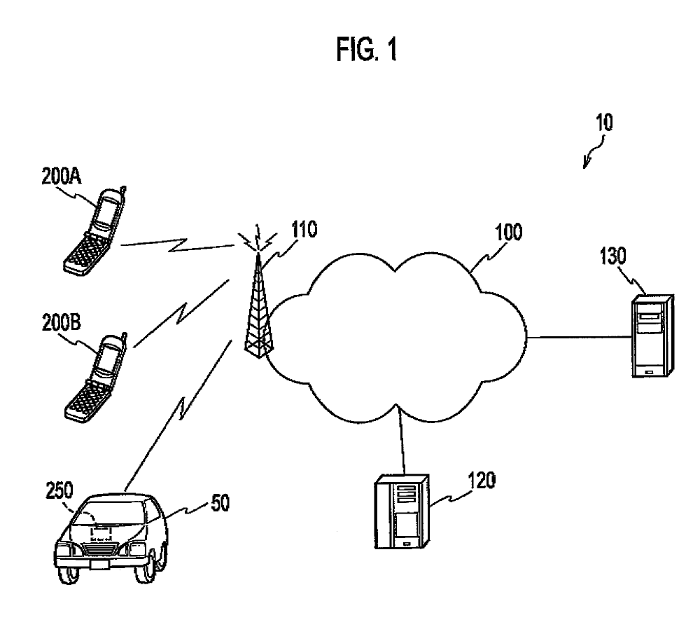

FIG. 1 is an overall schematic configuration diagram of a mobile communication system 10 including a radio communication device according to this embodiment.

The mobile communication system 10 is a mobile communication system using code division multiple access (CDMA). In the mobile communication system 10, radio communication is executed between a radio base station 110 and radio communication terminals 200A and 200B. Note that the numbers of the radio base stations and the radio communication terminals constituting the mobile communication system 10 is not limited to the numbers shown in FIG. 1.

The radio communication terminals (radio communication devices) 200A and 200B are cellular phone terminals having transmission/reception functions of voice calls and e-mails.

The radio communication terminals 200A and 200B have functions of receiving contents constituted of video images and the like. Specifically, the radio communication terminals 200A and 200B can receive the same contents as those simultaneously delivered to a plurality of destinations by broadcast or multicast in conformity with the specification of broadcast/multicast services (BCMCS).

In this embodiment, a radio communication card module 250 connected to a car navigation system (not shown) mounted to an automobile 50 can also provide the same function as those of the radio communication terminals 200A and 2003 in coordination with the car navigation system.

The radio base station 110, a BCMCS controller 120, and a contents server 130 are connected with each other by a communication network 100.

The BCMCS controller 120 controls the delivery of contents stored in the contents server 130 to the radio communication terminals 200A and 200B and the radio communication card module 250. Specifically, the BCMCS controller 120 executes control of delivery time for each of the contents and delivery routes for the contents of the BCMCS.

### (Functional Block Configuration of Radio Communication Device)

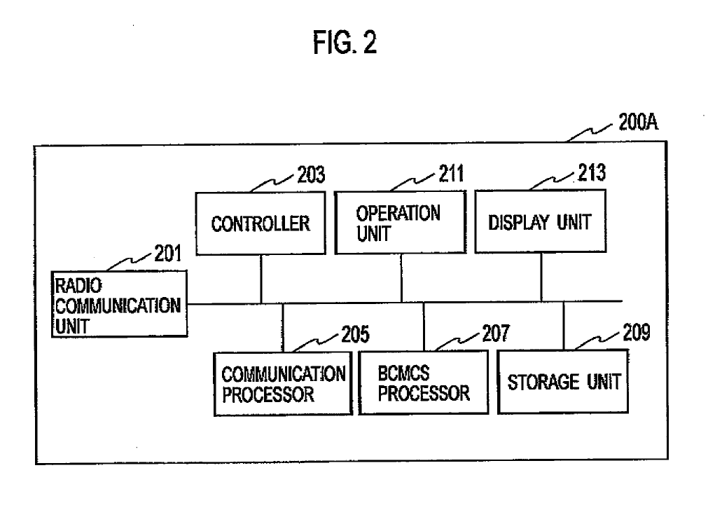

FIG. 2 is a functional block configuration diagram of the radio communication terminal 200A constituting the radio communication device according to this embodiment.

As shown in FIG. 2, the radio communication terminal 200A includes a radio communication unit 201, a controller 203, a communication processor 205, a BCMCS processor 207, a storage unit 209, an operation unit 211, and a display unit 213.

The radio communication terminal 200B has the same functional block configuration as that of the radio communication terminal 200A. Although the radio communication card module 250 (see FIG. 1) does not include the storage unit 209, the operation unit 211, and the display unit 213, the function is provided by the car navigation system (not shown) mounted to the automobile 50.

Portions relevant to the present invention will be mainly described below. Thus, it should be noted that the radio communication terminal 200A may include a logic block (e.g., power supply unit), which is necessary in achieving the function of the radio communication terminal 200A but is not shown in the drawings or omitted in the description.

The radio communication unit 201 transmits/receives radio signals in accordance with the CDMA. The radio communication unit 201 executes conversion between a baseband signal and a radio signal transmitted/received by the communication processor 205 and the BCMCS processor 207.

Specifically, the radio communication unit 201 converts the radio signal, which includes contents (delivery information) that the BCMCS processor 207 receives from the contents server 130, to the baseband signal (contents data).

Also, the radio communication unit 201 executes the conversion between the baseband signal and the radio signal for information other than the delivery information transmitted/received by the communication processor 205, specifically, data of voice calls, e-mails, and the like (non-delivery information).

That is, the radio communication unit 201 is shared by the BCMCS processor 207 and the communication processor 205. Therefore, the radio communication unit 201 cannot simultaneously process both of the delivery information processed by the BCMCS processor 207 and the non-delivery information processed by the communication processor 205. Thus, the radio communication unit 201 selects any one of the delivery information and the non-delivery information to perform sequential processing.

The controller 203 controls each of the functional blocks of the radio communication terminal 200A. Particularly, in this embodiment, the controller 203 controls transmission/reception of the delivery information and the non-delivery information. Specifically, the controller 203 can control (1) start of the voice call during reception of the delivery information, (2) reception of the delivery information during the voice call, and (3) reception of the delivery information at the start of the voice call.

Note that the controller 203 can control transmission/reception of e-mails in addition to voice calls in the same manner. What specifically is done for each control of (1) to (3) described above will be described below.

### (1) Start of Voice Call During Reception of Delivery Information

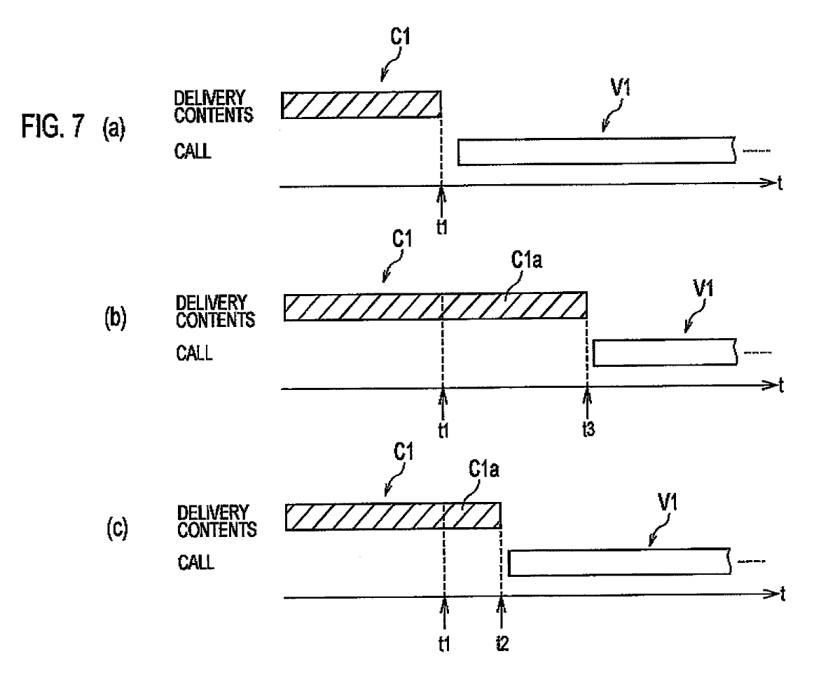

As shown in FIGS. 7(a) to 7(c), when an operation requiring transmission of voice call data V1 is performed, i.e., when the voice call is started, during reception of delivery contents C1, specifically, while the BCMCS processor 207 is receiving the delivery contents C1 via the radio communication unit 201, the controller 203 performs the control as follows.

The controller 203 controls whether or not to transmit the voice call data V1 (transmission non-delivery information), on the basis of the content of the voice call data V1 or the state of the delivery contents C1 (reception delivery information) being received by the BCMCS processor 207.

Specifically, the controller 203 controls whether or not to transmit the voice call data V1 (for example, a call signal associated with the start of the voice call) at a timing t1, on the basis of the phone number of the other party of the voice call to be started, the name of the delivery contents C1, the information amount of unreceived portion C1a (see FIGS. 7(b) and 7(c)) of the delivery contents C1, or the like.

When the information amount of the unreceived portion C1a not yet received of the delivery contents C1 being received by the BCMCS processor 207 is less than a predetermined threshold value (for example, 30 seconds of download time necessary for receiving the information amount of the unreceived portion C1a), the controller 203 can transmit the voice call data V1 after the reception of the delivery contents C1 is completed (timing t2 shown in FIG. 7(c)).

The controller 203 can control whether or not to transmit the voice call data V1, on the basis of an instruction from the operation unit 211. Particularly, when the unreceived portion C1a is greater than or equal to the predetermined threshold value (see FIG. 7(b)) or the like, control by the controller 203 in this manner is effective.

The controller 203 can control whether or not to transmit the voice call data V1, on the basis of the phone number (transmission destination identifier) showing a transmission destination of the voice call data V1.

Further, when the name of the delivery contents C1 stored in the storage unit 209, e.g., the name of a program (priority delivery information identifier) to be delivered, and the delivery contents C1 match, the controller 203 can cancel the transmission or reception of the voice call data V1 and continue the reception of the delivery contents C1.

### (2) Reception of Delivery Information During Voice Call

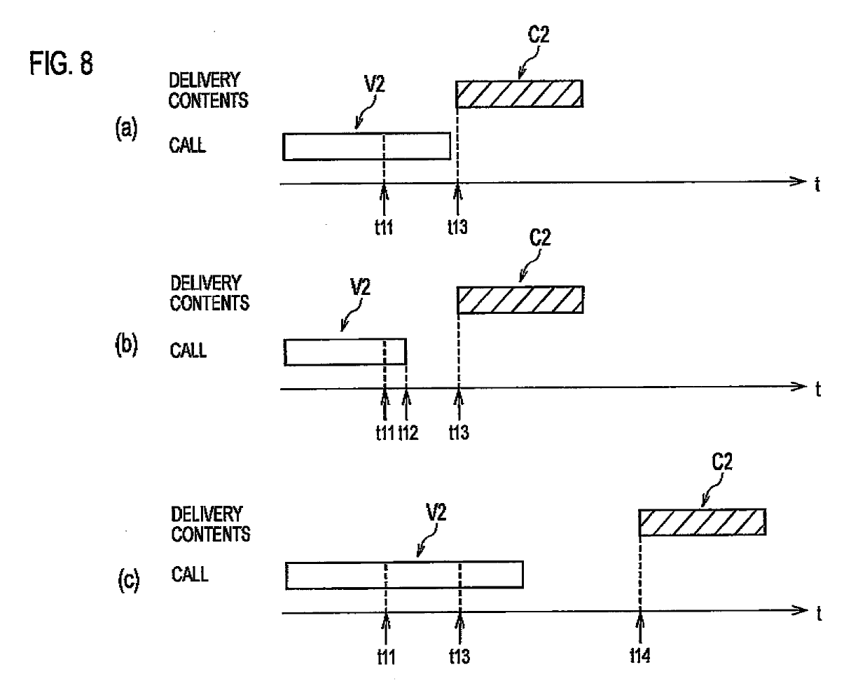

As shown in FIGS. 8(a) to 8(c), when it is necessary to receive delivery contents C2 during the voice call, specifically, when a delivery timing (timing t13) of the delivery contents C2 comes during the voice call, the controller 203 performs the control as follows.

When the delivery timing (timing t13) stored in the storage unit 209 comes while the communication processor 205 is transmitting or receiving voice call data V2 via the radio communication unit 201, the controller 203 controls whether or not to continue transmission or reception of the voice call data V2, on the basis of the content of the delivery contents C2 (target delivery information).

Note that, specifically, the controller 203 controls whether or not to continue the transmission or reception of the voice call data V2 at a timing t11, which is a predetermined time before the delivery timing (timing t13) (for example, 2 minutes).

When the delivery contents C2 is to be redelivered after the timing t13 (at a timing t14), the controller 203 can continue the transmission or reception of the voice call data V2. When the delivery information is not to be redelivered after the timing t13, the controller 203 can inform that the delivery contents C2 are not to be redelivered while continuing the transmission or reception of the voice call data V2.

When the name of the delivery contents C2 stored in the storage unit 209, e.g., the name of a program (priority delivery information identifier) to be delivered, and the delivery contents C2 match, the controller 203 informs of this accordingly and cancels the transmission or reception of the voice call data V2. As a result, the BCMCS processor 207 can receive the delivery contents C2.

Further, the controller 203 can control whether or not to continue the transmission or reception of the voice call data V2, on the basis of the transmission destination identifier (for example, phone number) showing the transmission destination or the transmission source of the voice call data V2.

### (3) Reception of Delivery Information at Start of Voice Call

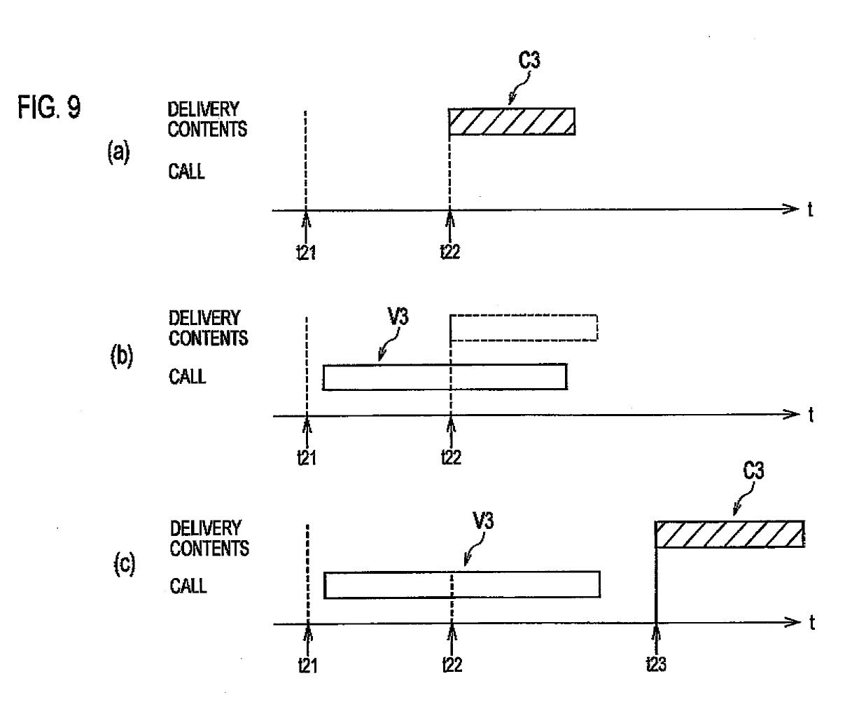

As shown in FIGS. 9(a) to 9(c), when it is necessary to receive delivery contents C3 at the start of the voice call, specifically, when a delivery timing (timing t22) of the delivery contents C3 is approaching at the start of the voice call, the controller 203 performs the control as follows.

When an operation requiring transmission of voice call data V3 is performed between a determination timing (timing t21), which is a predetermined time before a delivery timing (timing t22) stored in the storage unit 209 (for example, 2 minutes), and the delivery timing, the controller 203 controls whether or not to transmit the voice call data V3, on the basis of the content of the voice call data V3 (transmission non-delivery information) or the content of delivery contents C3 (target delivery information).

When the delivery contents C3 are to be redelivered after the timing t22 (at a timing t23), the controller 203 can transmit the voice call data V3. When the delivery contents C3 are not to be redelivered after the timing t22, the controller 203 can inform that the delivery contents C3 are not to be redelivered before transmitting the voice call data V3.

When the name of the delivery contents C3 stored in the storage unit 209, e.g., the name of a program (priority delivery information identifier) to be delivered, and the delivery contents C3 match, the controller 203 can cancel the transmission of the voice call data V3 and continue the reception of the delivery contents C3.

Further, the controller 203 can control whether or not to transmit the voice call data V3, on the basis of the transmission destination identifier (for example, phone number) showing the transmission destination of the voice call data V3.

The communication processor 205 executes processing related to the transmission or reception of the non-delivery information (for example, voice call data V1) other than the delivery information (for example, delivery contents C1).

The BCMCS processor 207 receives the delivery information delivered by the contents server 130. In this embodiment, the BCMCS processor 207 constitutes a delivery information processor.

Specifically, the BCMCS processor 207 receives the same contents as those simultaneously delivered to two or more destinations by broadcast or multicast in conformity with the specification of the broadcast/multicast services (BCMCS).

The storage unit 209 stores phone numbers or e-mail addresses (transmission destination identifiers) and e-mails, and the like. Also, the storage unit 209 can store the delivery timing (for example, timing t13 shown in FIGS. 8(a) to 8(c)) of the delivery information and the name of the delivery contents (priority delivery information identifier), reception of which is prioritized over transmission or reception of the non-delivery information (for example, voice call data V2).

The operation unit 211 is constituted of various keys operated by the user of the radio communication terminal 200A and a vibrator.

Particularly, in this embodiment, when the information amount the unreceived portion C1a (see FIGS. 7(b) and 7(c)) not yet received of the delivery contents C1 (delivery contents C1) being received by the BCMCS processor 207 is greater than or equal to a predetermined threshold value, the operation unit 211 lets the user of the radio communication terminal 200A select any one of continuation of the reception of the delivery contents C1 and transmission of the voice call data V1. In this embodiment, the operation unit 211 and the display unit 213 constitute a selection processor.

The operation unit 211 can let the user of the radio communication terminal 200A designate the priority delivery information (for example, delivery contents C2), reception of which is prioritized over transmission or reception of the non-delivery information (for example, voice call data V2), from multiple pieces of the delivery information.

Further, the operation unit 211 can store the name of the delivery contents C2 (priority delivery information identifier) designated by the user in the storage unit 209. In this embodiment, the operation unit 211 and the display unit 213 constitute a designation processor.

The display unit 213 is constituted of a small display instrument. The display unit 213 displays various information based on the control by the controller 203.

### (Operation of Radio Communication Device)

Next, the operation of the radio communication terminal 200A described above will be described. Specifically, (1) start of the voice call (transmission of an e-mail) during reception of the delivery information, (2) reception of the delivery information during the voice call, and (3) reception of the delivery information at the start of the voice call will be described.

### (1.1) Start of Voice Call During Reception of Delivery Information

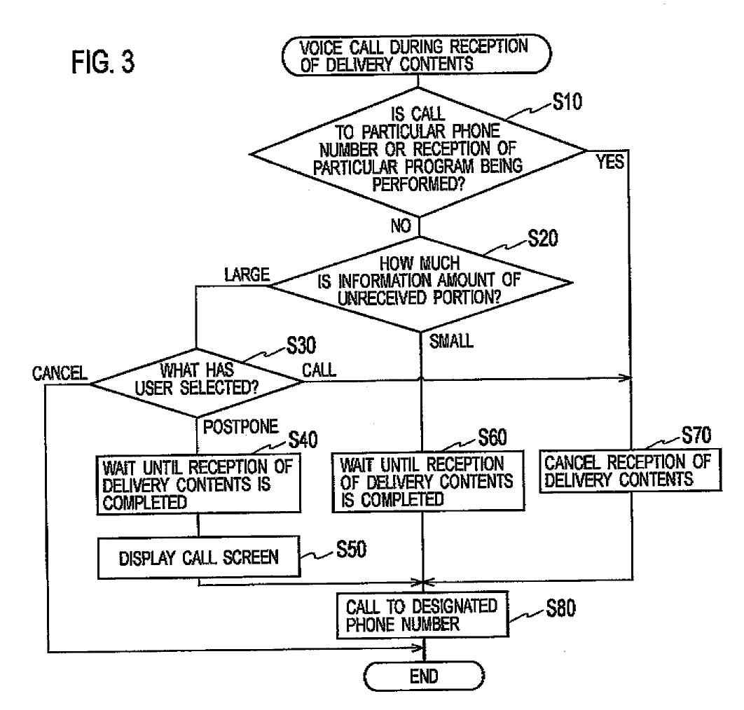

FIG. 3 shows an operation flow for when the radio communication terminal 200A starts the voice call during the reception of the delivery information delivered by the BCMCS. FIGS. 7(a) to 7(c) show the states of the delivery contents C1 (delivery information) and the voice call data V1 transmitted or received by the radio communication terminal 200A.

In step S10, the radio communication terminal 200A determines either whether or not a call to a particular phone number is about to be made, or whether or not the delivery contents C1 currently being received corresponds to a particular program.

Specifically, the radio communication terminal 200A executes the determination based on the phone number (transmission destination identifier) stored in the storage unit 209 and the name of the delivery contents C1 (priority delivery information identifier).

When the call to the particular phone number is not about to be made or correspondence with a particular program is not present (No in step S10), in step S20 the radio communication terminal 200A determines the information amount (for example, whether or not the information amount is less than 1 Mb) of the unreceived portion C1a not yet received. Note that the radio communication terminal 200A may execute the determination based on the download time necessary for receiving the unreceived portion C1a.

When the information amount of the unreceived portion C1a is large, i.e., when the unreceived portion C1a is greater than or equal to 1 Mb (“LARGE” in step S20), in step S30 the radio communication terminal 200A displays a screen for the user of the radio communication terminal 200A to confirm whether or not to call the designated phone number, and lets the user select an operation to be executed.

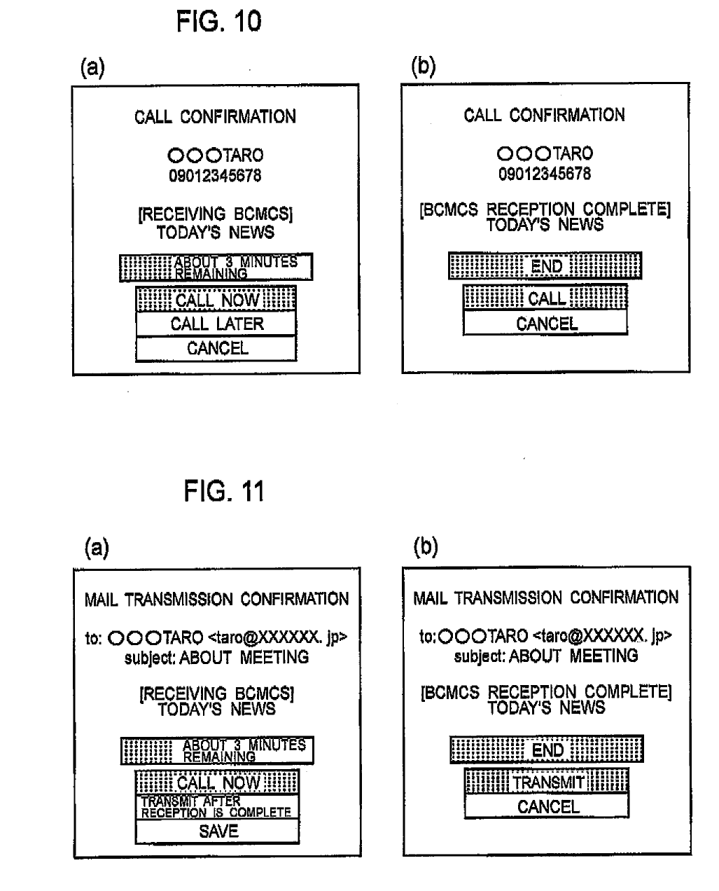

FIG. 10(a) shows an example of a screen displayed in step S30. As shown in FIG. 10(a), the radio communication terminal 200A lets the user select any one of “call now” (call), “call later” (postpone), and “cancel.”

When “call later” is selected (“postpone” in step S30), in step S40 the radio communication terminal 200A waits without calling the designated phone number until the reception of the delivery contents C1 is completed at a timing t3 (see FIG. 7(b)).

In step S50, when the timing t3 comes, the radio communication terminal 200A displays the screen showing that the call to the designated phone number is to be made.

FIG. 10(b) shows an example of a screen displayed in step S50. Note that, as shown in FIG. 10(b), the radio communication terminal 200A can let the user select cancellation of the call to the designated number.

When the information amount of the unreceived portion C1a is small, i.e., the unreceived portion C1a is less than 1 Mb (“SMALL” in step S20), in step S60 the radio communication terminal 200A waits without calling the designated phone number until the reception of the delivery contents C1 is completed at the timing t2 (see FIG. 7(c)).

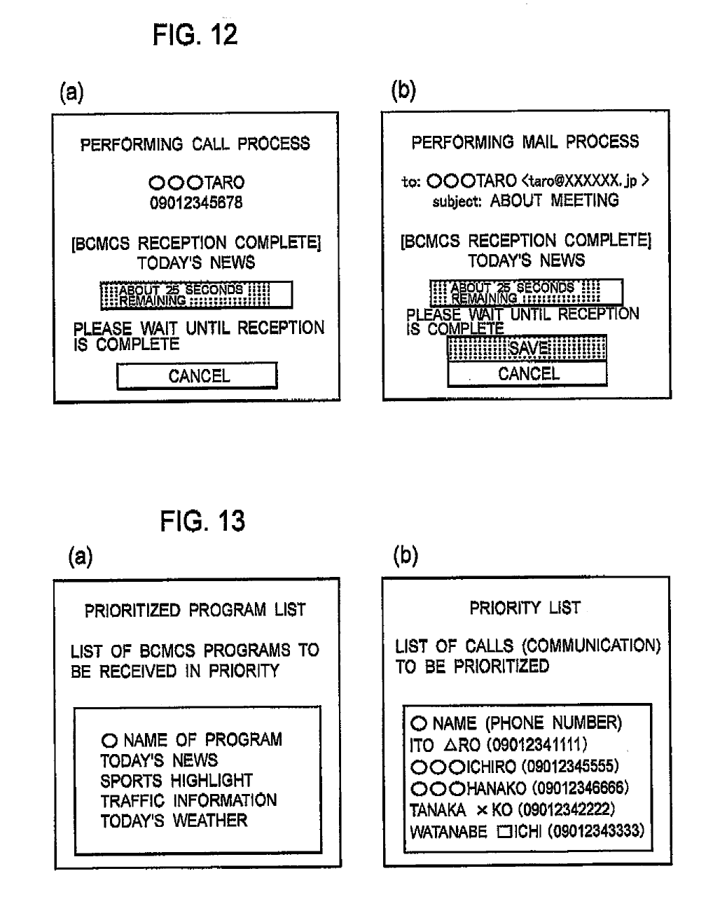

FIG. 12(a) shows an example of a screen displayed in step S60. As shown in FIG. 12(a), the radio communication terminal 200A displays the fact that the delivery contents C1 axe being received and a time remaining until the completion of the reception. Note that the radio communication terminal 200A does not have to display the remaining time.

When the call to a particular phone number is about to be made or correspondence with a particular program is present, or when “call now” is selected (YES in step S10), in step S70 the radio communication terminal 200A aborts the reception of the delivery contents C1 at the timing t1 (see FIG. 7(a)).

In step S80, the radio communication terminal 200A calls the designated phone number.

### (1.2) Transmission of E-Mail During Reception of Delivery Information

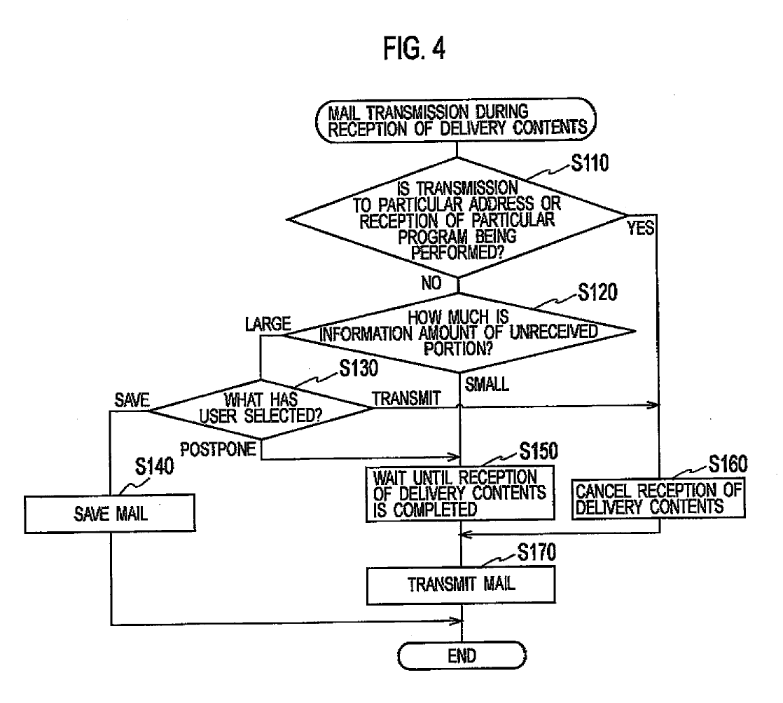

FIG. 4 shows an operation flow for when the radio communication terminal 200A transmits e-mail during the reception of the delivery contents C1. Note that, since the operation flow is approximately the same as the operation flow shown in FIG. 3 for when the voice call is started during the reception of the delivery contents C1, portions differing from the operation flow shown in FIG. 3 will be described below.

In step S130, the radio communication terminal 200A displays a screen for the user of the radio communication terminal 200A to confirm whether or not to transmit the designated e-mail immediately, and lets the user select an operation to be executed.

FIG. 11(a) shows an example of a screen displayed in step S130. Note that, when an e-mail to be transmitted is not transmitted in an e-mail transmission, the e-mail can be saved.

FIG. 11(b) shows an example of a screen displayed in step S 150. Specifically, FIG. 11(b) shows an example of a screen displayed when the reception of the delivery contents C1 is completed. Note that, in step S150, the radio communication terminal 200A may display an example of a screen shown in FIG. 12(b) instead of the example of the screen shown in FIG. 11(b). That is, the radio communication terminal 200A can let the user select saving without transmitting the e-mail, or cancelling the transmission, while waiting until the reception of the delivery contents C1 is completed.

### (1.3) Registration of Particular Phone Number and Program

FIGS. 13(a) and 13(b) show examples of screens relating to a particular phone number (transmission destination identifier) and the name of a particular program (priority delivery information identifier) used for the process in step S10 (S110) described above.

Specifically, FIG. 13(a) shows a list of delivery contents (programs) to be received in priority over the voice call. As shown in FIG. 13(a), “TODAY'S NEWS,” “SPORTS HIGHLIGHT,” “TRAFFIC INFORMATION,” and “TODAY'S WEATHER,” are registered as programs to be received in priority over the voice call.

FIG. 13(b) shows a list of phone numbers (user names) for which the voice call is to be started in priority over the reception of the delivery contents. As shown in FIG. 13(b), particular phone numbers (for example, 09012341111) are registered as the phone numbers for which the voice call is to be started in priority over the reception of the delivery contents.

### (2) Reception of Delivery Information During Voice Call

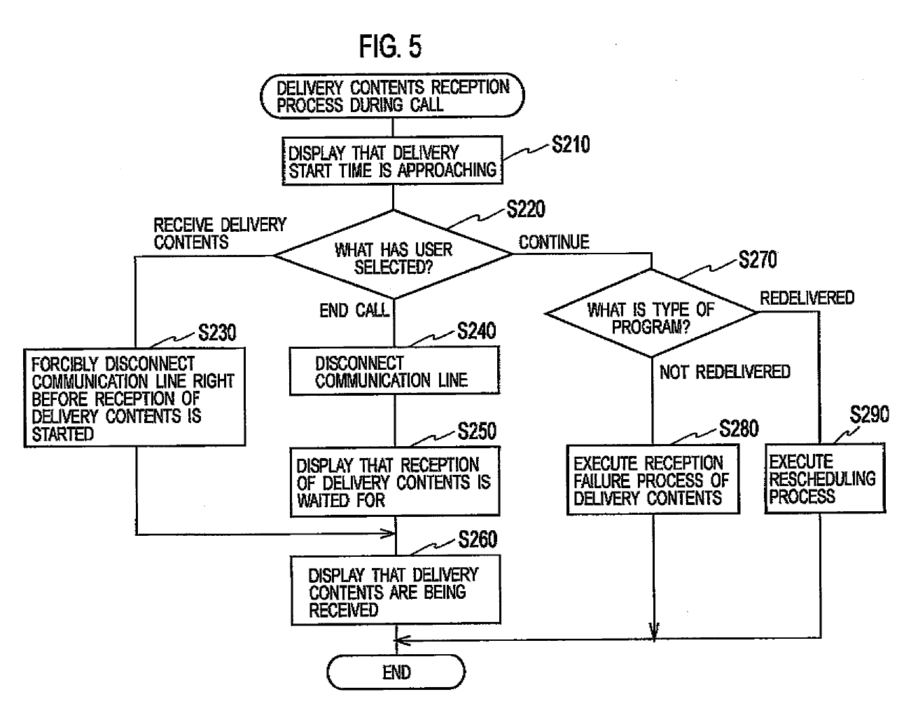

FIG. 5 shows an operation flow for when the radio communication terminal 200A receives the delivery information delivered by the BCMCS during the voice call. FIGS. 8(a) to 8(c) show the states of the delivery contents C2 (delivery information) and the voice call data V2 transmitted or received by the radio communication terminal 200A.

In step S210, the radio communication terminal 200A displays the fact that a delivery start time of the delivery contents C2 to be received is approaching during the voice call. Specifically, the radio communication terminal 200A displays the fact that the delivery start time of the delivery contents C2 is approaching at the timing t11 (see FIG. 8(a)).

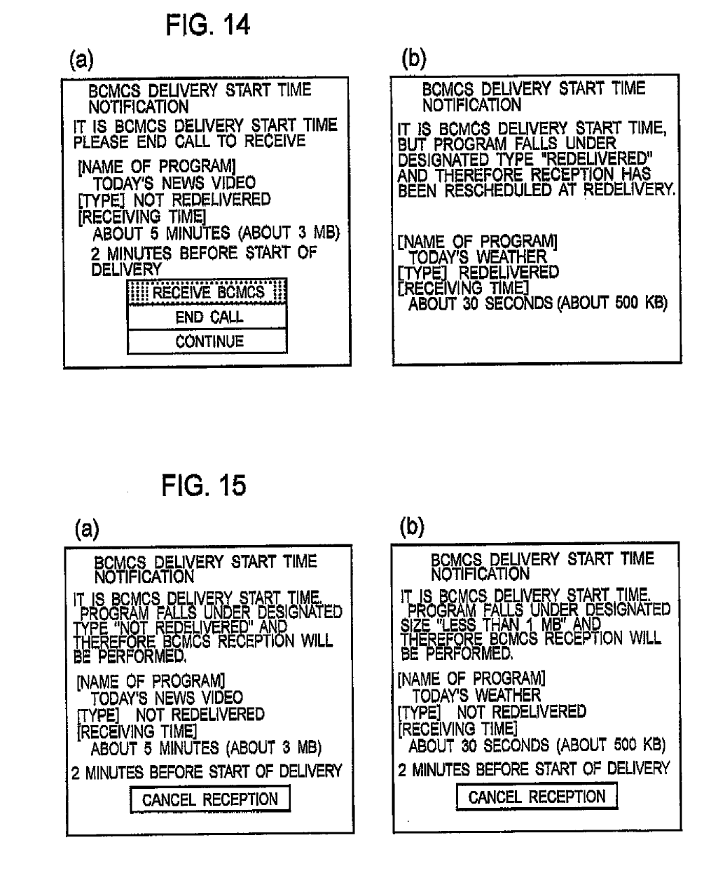

FIG. 14(a) shows an example of a screen displayed in step S210. As shown in FIG. 14(a), the radio communication terminal 200A lets the user select any one of “RECEIVE DELIVERY CONTENTS” to receive the delivery contents, “END CALL” to end the voice call, and “CONTINUE” to continue the voice call.

In step S220, the radio communication terminal 200A determines which one of the “RECEIVE DELIVERY CONTENTS,” “END CALL,” and “CONTINUE” the user has selected.

When “RECEIVE DELIVERY CONTENTS” is selected (“RECEIVE DELIVERY CONTENTS” in step S220), in step S230 the radio communication terminal 200A forcibly disconnects a communication line set for the voice call right before the reception of the delivery contents C2 is started.

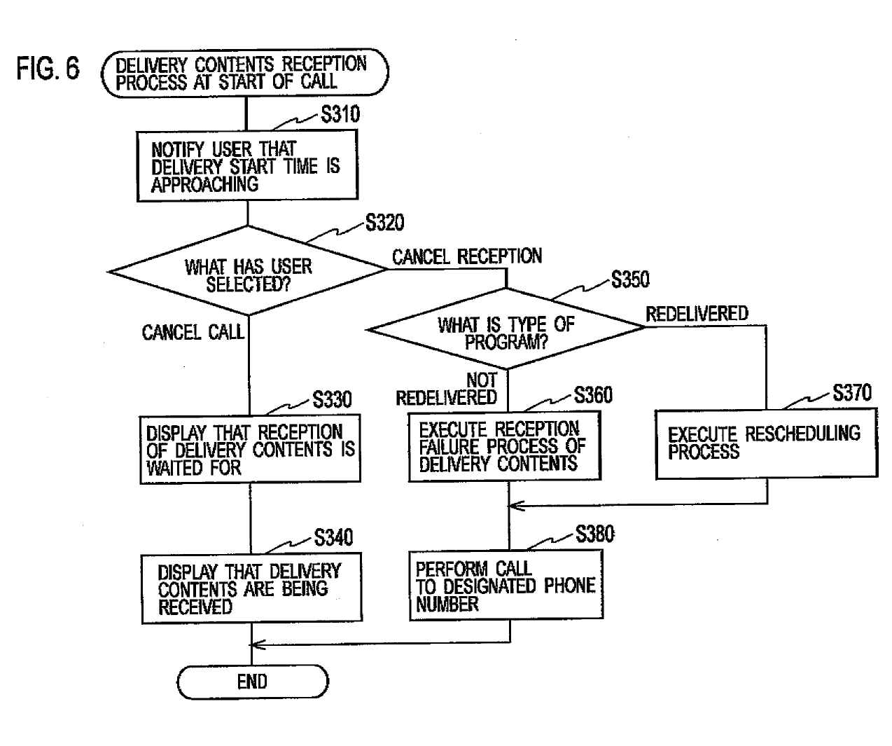

Specifically, the radio communication terminal 200A forcibly disconnects the communication line used for transmission/reception of the voice call data V2 at a timing t12 (see FIG. 6(b)).

When “END CALL” is selected (“END CALL” in step S220), in step S240 the radio communication terminal 200A disconnects the communication line set for the voice call in response to an operation to end the call by the user.

Specifically, the radio communication terminal 200A disconnects the communication line used for the transmission/reception of the voice call data V2 before the timing t13 (see FIG. 8(a)) which is the delivery start time.

In step S250, the radio communication terminal 200A displays the fact that the reception of the delivery contents C2 is being waited for.

In step S260, when the delivery start time of the delivery contents C2 (timing t13) comes, the radio communication terminal 200A starts the reception of the delivery contents C2 and displays the fact that the delivery contents C2 are being received.

On the other hand, when “CONTINUE” is selected (“CONTINUE” in step S220), in step S270 the radio communication terminal 200A determines whether or not the delivery contents C2 (program) are to be redelivered.

When the delivery contents C2 are not to be redelivered (“NOT REDELIVERED” in step S270), in step S280 the radio communication terminal 200A executes a reception failure process of the delivery contents C2 along with a loss of opportunity for receiving the delivery contents C2 due to continuation of the voice call.

When the delivery contents C2 are to be redelivered (“REDELIVERED” in step S270), in step S290 the radio communication terminal 200A executes a rescheduling processing for reception of the delivery contents C2.

Specifically, when the delivery contents C2 are to be redelivered at the timing t14 (see FIG. 8(c)), the radio communication terminal 200A changes a reception schedule so that the reception of the delivery contents C2 is started from the timing t14.

FIG. 14(b) shows an example of a screen displayed in step S290. As shown in FIG. 14(b), the radio communication terminal 200A displays the fact that the delivery contents C2 are to be redelivered and that the reception of the delivery contents C2 has been rescheduled.

### (3) Reception of Delivery Information at Start of Voice Call

FIG. 6 is an operation flow for when the delivery time of the delivery information to be delivered by the BCMCS is approaching at the start of the voice call by the radio communication terminal 200A. FIGS. 9(a) to 9(c) show the states of the delivery contents C3 (delivery information) and the voice call data V3 transmitted or received by the radio communication terminal 200A.

When the start of the voice call is requested by the user, specifically, a call operation of the voice call is performed, in step S310 the radio communication terminal 200A displays the fact that the delivery start time of the delivery contents C3 to be received is approaching. Specifically, the radio communication terminal 200A displays the fact that the delivery start time of the delivery contents C3 is approaching, when the call operation is performed between the timing t21 and the timing t22 (see FIG. 9(a)).

Specifically, the radio communication terminal 200A lets the user select any one of “CANCEL CALL” to cancel the call of the voice call and “CANCEL RECEPTION” to cancel the reception of the delivery contents C3.

In step S320, the radio communication terminal 200A determines which one of the “CANCEL CALL” and “CANCEL RECEPTION” the user has selected.

When “CANCEL CALL” is selected (“CANCEL CALL” in step S320), the radio communication terminal 200A executes processings of steps S330 and S340. The processings of steps S330 and S340 are approximately the same as the processings of steps S250 and S260 (see FIG. 5).

When “CANCEL RECEPTION” is selected (“CANCEL RECEPTION” in step S320), the radio communication terminal 200A executes the processings of steps S350 to S370. The processings of steps S350 to S370 are approximately the same as the processings of steps S270 to S290 (see FIG. 5).

When the delivery contents C3 are to be redelivered at the timing t23 (see FIG. 9(c)), in the processing of step S370 the radio communication terminal 200A changes the reception schedule so that the reception of the delivery contents C2 is started from the timing t23.

In step S380, the radio communication terminal 200A calls the designated phone number. Then, the transmission/reception of the voice call data V3 using the communication line set by the call operation is continued after the timing t22 which is the delivery start time of the delivery contents C3 (see FIGS. 9(b) and 9(c)).

### (4) Modified Example

In the operation flows shown in FIGS. 5 and 6, the reception failure process is executed (steps S280 and S360) without receiving the delivery contents, when the delivery contents are not to be redelivered.

The radio communication terminal 200A may forcibly receive the delivery contents, which are not to be redelivered, instead of executing the reception failure process. FIG. 15(a) shows an example of a screen displayed when the delivery contents, which are not to be redelivered, is forcibly received.

Also, the radio communication terminal 200A may forcibly receive the delivery contents in accordance with the information amount of the delivery contents regardless of whether or not the delivery contents are to be redelivered. FIG. 15(b) shows an example of a screen displayed when the delivery contents are forcibly received in accordance with the information amount of the delivery contents.

### EFFECTS AND ADVANTAGES

With the radio communication terminal 200A, when the reception of the delivery contents and the voice call conflict with each other, whether or not to receive the delivery contents can be determined, without an intervention of a user operation, according to the state of the delivery contents (for example, the information amount of the unreceived portion C1a or whether or not the delivery contents are to be redelivered).

Also, with the radio communication terminal 200A, when the reception of the delivery contents and the voice call conflict with each other, the user can select which one of the reception of the delivery contents and the voice call is to be prioritized by a simple operation.

That is, with the radio communication terminal 200A, even though the radio communication unit 201 is shared for the reception of the delivery contents (delivery information) and the transmission or reception of the voice call data (non-delivery information) conflict with each other, the operability of the radio communication terminal 200A when the reception of the delivery contents and the voice call can be improved. Further, with the radio communication terminal 200A, necessary delivery contents can be more reliably received.

### Other Embodiments

As described above, the content of the present invention has been disclosed through one embodiment of the present invention. However, the descriptions and the drawings constituting a part of the disclosure should not be construed to limit the present invention. Various alternative embodiments should be obvious to those skilled in the art from this disclosure.

For example, the radio communication terminal 200A does not necessarily have to perform all of the operations shown in FIGS. 3 to 6. For example, the radio communication terminal 200A may execute only the operations shown in FIGS. 3 and 4.

In the embodiment described above, information is provided to the user by a screen displayed by the display unit 213. However, information may be provided by a vibration of a vibrator or an acoustic signal, instead of or together with the screen display.

In this manner, it is needless to say that the present invention includes various embodiments not described herein. Thus, the technical scope of the present invention is defined only by invention identifying matters according to the scope of claims appropriate to the descriptions above.

Note that the disclosures of Japanese Patent Application No. 2006-019477 (filed on Jan. 27, 2006), Japanese Patent Application No. 2006-019484 (filed on Jan. 27, 2006), and Japanese Patent Application No. 2006-019485 (filed on Jan. 27, 2006) are incorporated herein by reference in their entirety.

### INDUSTRIAL APPLICABILITY

As described above, a radio communication device according to the present invention is useful for radio communication such as mobile communication, since operability is improved and necessary delivery information can more reliably be received, when a radio communication unit is shared for reception of delivery information and transmission or reception of non-delivery information.

1. A radio communication device comprising:
a delivery information processor configured to receive delivery information on identical contents simultaneously delivered to a plurality of transmission destinations;
a communication processor configured to execute a processing relating to transmission or reception of non-delivery information other than the delivery information;
a radio communication unit shared by the delivery information processor and the communication processor, and configured to select and process any one of the delivery information and the non-delivery information; and
a controller configured to, when an operation requiring transmission of the non-delivery information is performed while the delivery information processor is receiving the delivery information via the radio communication unit, control whether or not to transmit transmission non-delivery information according to the operation on the basis of either a content of the transmission non-delivery information or a state of reception delivery information being received by the delivery information processor.

2. The radio communication device according to claim 1, further comprising:
a selection processor configured to let a user of the radio communication device select any one of continuation of reception of the reception delivery information and transmission of the transmission non-delivery information, when an information amount of an unreceived portion not yet received of the reception delivery information is greater than or equal to a predetermined threshold value,
wherein the controller controls whether or not to transmit the transmission non-delivery information on the basis of an instruction from the selection processor.

3. The radio communication device according to claim 1, wherein the controller transmits the transmission non-delivery information after the reception of the reception delivery information is completed, when the information amount of the unreceived portion not yet received of the reception delivery information is less than the predetermined threshold value.

4. The radio communication device according to claim 1, wherein the controller controls whether or not to transmit the transmission non-delivery information on the basis of a transmission destination identifier indicating a transmission destination of the transmission non-delivery information.

5. The radio communication device according to claim 1, further comprising: a designation processor configured to let the user of the radio communication device designate priority delivery information to be received in priority over the transmission or reception of the non-delivery information, and to store a priority delivery information identifier indicating the designated priority delivery information in a storage unit,
wherein the controller cancels the transmission or reception of the non-delivery information, and continues the reception of the reception delivery information, when the reception delivery information matches with the priority delivery information identifier stored in the storage unit.

6. A radio communication device comprising:
a delivery information processor configured to receive delivery information on identical contents simultaneously delivered to a plurality of transmission destinations;
a communication processor configured to execute a processing relating to transmission or reception of non-delivery information other than the delivery information;
a radio communication unit shared by the delivery information processor and the communication processor, and configured to select and process any one of the delivery information and the non-delivery information;
a storage unit configured to store at least a delivery timing of the delivery information; and
a controller configured to control whether or not to continue the transmission or reception of the non-delivery information on the basis of a content of target delivery information to be received at the delivery timing, when the delivery timing stored in the storage unit comes while the communication processor is transmitting or receiving the non-delivery information via the radio communication unit.

7. The radio communication device according to claim 6, wherein the controller continues the transmission or reception of the non-delivery information, when the target delivery information is to be redelivered after the delivery timing.

8. The radio communication device according to claim 6, wherein the controller informs that the target delivery information is not to be redelivered while continuing the transmission or reception of the non-delivery information, when the target delivery information is not to be redelivered after the delivery timing.

9. The radio communication device according to claim 6, further comprising: a designation processor configured to let the user of the radio communication device designate priority delivery information to be received in priority over the transmission or reception of the non-delivery information, and to store a priority delivery information identifier indicating the designated priority delivery information in the storage unit,
wherein the controller cancels the transmission or reception of the non-delivery information and receives the target delivery information when the target delivery information matches with the priority delivery information identifier stored in the storage unit.

10. The radio communication device according to claim 6, wherein the controller controls whether or not to continue the transmission or reception of the non-delivery information on the basis of a transmission destination identifier indicating a transmission destination or a transmission source of the non-delivery information.

11. A radio communication device comprising:
a delivery information processor configured to receive delivery information on identical contents simultaneously delivered to a plurality of transmission destinations;
a communication processor configured to execute a processing relating to transmission or reception of non-delivery information other than the delivery information;
a radio communication unit shared by the delivery information processor and the communication processor, and configured to select and process any one of the delivery information and the non-delivery information;
a storage unit configured to store at least a delivery timing of the delivery information; and
a controller configured to, when an operation requiring transmission of the non-delivery information is performed between a determination timing which is a predetermined time before the delivery timing stored in the storage unit, and the delivery timing, control whether or not to transmit transmission non-delivery information according to the operation on the basis of either a content of the transmission non-delivery information or a content of target delivery information to be received by the delivery information processor.

12. The radio communication device according to claim 11, wherein the controller transmits the transmission non-delivery information, when the target delivery information is to be redelivered after the delivery timing.

13. The radio communication device according to claim 11, wherein the controller informs that the target delivery information is not to be redelivered, before transmitting the transmission non-delivery information, when the target delivery information is not to be redelivered after the delivery timing.

14. The radio communication device according to claim 11, further comprising: a designation processor configured to let the user of the radio communication device designate priority delivery information to be received in priority over the transmission or reception of the non-delivery information, and to store a priority delivery information identifier indicating the designated priority delivery information in the storage unit;
wherein the controller cancels the transmission of the transmission non-delivery information and receives the target delivery information, when the target delivery information matches with the priority delivery information identifier stored in the storage unit.

15. The radio communication device according to claim 11, wherein the controller controls whether or not to transmit the non-delivery information on the basis of a transmission destination identifier indicating a transmission destination of the transmission non-delivery information.
